(19) United States
(12) Patent Application Publication
(10) Pub. No.: US 2016/0002416 A1
(43) Pub. Date: Jan. 7, 2016

(54) STYRENE-ETHYLENE/BUTYLENE-STYRENE BLOCK COPOLYMER DEVICES

(71) Applicant: UNIVERSITY OF WASHINGTON THROUGH ITS CENTER FOR COMMERCIALIZATION, Seattle, WA (US)

(72) Inventors: Jonathan Posner, Seattle, WA (US); Mark Borysiak, Seattle, WA (US)

(73) Assignee: University of Washington through its Center for Commercialization, Seattle, WA (US)

(21) Appl. No.: 14/760,681

(22) PCT Filed: Jan. 15, 2014
(86) PCT No.: PCT/US2014/011679

§ 371 Date: Jul. 13, 2015

Related U.S. Application Data
(60) Provisional application No. 61/752,613, filed on Jan. 15, 2013.

(51) Int. Cl. C08J 5/00; B29C 39/00; B29C 65/00; C08J 5/12

(52) U.S. Cl. CPC C08J 5/00; C08J 5/12; B29C 39/003; B29C 66/7465; B29C 66/7317; C08J 2353/00; C08L 25/06

(57) ABSTRACT

This disclosure describes polymeric devices including a polystyrene-b-poly(ethylene-co-butylene)-b-polystyrene having a styrene content of between 15 wt % and 70 wt %. The polymeric devices include a predetermined structural feature having a dimension of 20 nm to 1 cm. The polymeric devices can have a surface and a bulk volume, and the styrene content of the surface can differ from the styrene content of the bulk volume of the polymeric devices.

### CROSS-REFERENCE TO RELATED APPLICATION

This application claims the benefit of U.S. Patent Application No. 61/752,613, filed Jan. 15, 2013, herein incorporated by reference in its entirety.

### FIELD OF THE INVENTION

This disclosure is directed to polymeric devices having structural features and to methods of making these polymeric devices. The polymeric devices include polystyrene-b-poly(ethylene-co-butylene)-b-polystyrene.

### BACKGROUND

Polymeric devices, such as micro/milliscale lab-on-a-chip (LOC) devices, are an important tool for cellular biology research. LOC devices offer advantages over traditional macro-scale experiments due to the decreased physical scale of the systems and the resultant control of the cellular environment. Specifically, micro/milliscale systems offer unprecedented control of the cellular microenvironment at physically relevant length and time scales associated with cellular functions and cell-based applications. These systems offer great potential in a number of applications including drug discovery, the understanding of complex cell-cell interactions, biomechanical studies, and medical diagnostics. Despite recent advancements, the full impact of micro/millifluidics on cellular biology studies has not yet been realized, in part because there is often a compromise in device material selection with respect to the specific research questions under consideration. There is a need for materials with ideal properties for cellular biology micro/millifluidic applications, including: simple microfabrication routes, low cost, chemical stability, and biocompatibility.

Polystyrene (PS) is a hard glassy thermoplastic polymer that has been used for cellular biology research and can be found in many tissue culture plasticware. For biological and chemical applications, PS can have low cost, optical transparency, biocompatibility, low auto-fluorescence, chemical stability, and the ability to be chemically functionalized at the surface. However, for micro/millifluidic applications, microfabrication of hard, glassy thermoplastic materials, such as PS, is more challenging when compared to elastomeric materials such as polydimethylsiloxane (PDMS). Hard thermoplastics such as PS have traditionally relied on techniques such as injection molding and hot embossing for the replication of micro- or milli-structural features, which may not be practical or suitable for rapid prototyping of LOC devices.

In contrast to elastomeric polymers, such as PDMS, which can replicate micro/milli-structures utilizing soft lithographic methods by conforming and sealing to substrates such as glass, PS and hard thermoplastics require more challenging methods such as thermal pressing and solvent bonding to create uniform interfacial contact with other substrates. However, maintaining feature fidelity can be difficult during both thermal and solvent bonding, as PS begins to deform considerably below its glass transition temperature and solvent bonding changes the surface structure and geometry.

Furthermore, creating access ports (e.g., for liquids) for micro/millifluidic devices in thermoplastics can be time-consuming, requiring the use of manual drilling, whereas in more compliant polymers such as PDMS, access ports can be manually punched or directly integrated during molding, allowing for simplified interfacing with external equipment.

While elastomeric polymers such as PDMS can have advantages during the fabrication stage, intrinsic limitations exist for their use in LOC experiments, particularly for cell-based studies. Specifically, diffusion of small hydrophobic molecules into the elastomeric polymer bulk can significantly impact protein activation and drug discovery experiments, as well as create bias error and background noise for quantitative fluorescence measurements. Elastomeric polymers such as PDMS also contain uncross-linked oligomers that are able to move throughout the polymer bulk and may leach into micro/millifluidic solutions during experiments, potentially affecting cell membrane studies. Other issues with elastomeric polymers, such as PDMS, involve its surface properties and high gas solubility. For example, the surface of PDMS is highly hydrophobic and often requires surface treatment to render it hydrophilic for applications such as electrophoretic separations and bioassays. Oxygen plasma treatment is commonly employed, but the hydrophobic recovery in PDMS is very fast, often occurring within hours if left in open air. High gas permeability has been cited as an advantage for cell culture studies in PDMS, but it can also potentially create a hyperoxic environment that is toxic to cells. The high permeability to water vapor can lead to changes in concentration and osmolality of micro/millifluidic solutions contained within the elastomeric polymeric device, affecting cell culture conditions and assay readouts. The high gas solubility combined with the unstable surface properties—particularly post-oxidation hydrophobic recovery—can result in difficulty filling channels and spontaneous formation of bubbles in micro/millichannels in a micro/millifluidic device, adversely affecting experimental outcomes. Chemical modifications can alleviate these issues, but require additional steps and introduce new complexities.

Thus, it is desirable for polymeric devices to combine the favorable properties of PS as well as benefitting from ease of replication and fabrication processes of elastomeric materials such as PDMS.

### SUMMARY

This disclosure, inter alia, relates to polymeric devices that include a polystyrene-b-poly(ethylene-co-butylene)-b-polystyrene having a relatively high styrene content (e.g., greater than 15 wt %, or greater than 20 wt %) and to methods for making the polymeric devices. The polymeric devices can be used, for example, in biological applications such as cell culture plasticware, in microfluidic or millifluidic devices.

In one aspect, this disclosure features an article including a polystyrene-b-poly(ethylene-co-butylene)-b-polystyrene having a styrene content of between 15 wt % and 70 wt %. The article includes a predetermined structural feature having a dimension of 20 nm to 1 cm. In another aspect, this disclosure features an article including a polystyrene-b-poly(ethylene-co-butylene)-b-polystyrene having a bulk styrene content of between 15 wt % and 70 wt % and a surface styrene content that is different from the bulk styrene content. The article include a predetermined structural feature having a dimension of 20 nm to 1 cm.

In yet another aspect, this disclosure features a method of making an article, including providing a mold including a predetermined structural feature imprint; supplying the mold with a polystyrene-b-poly(ethylene-co-butylene)-b-polystyrene; setting the polystyrene-b-poly(ethylene-co-butylene)-b-polystyrene to provide an article of claim 1; and removing the article from the mold. The mold can include a hydrophilic surface, a hydrophobic surface, or a combination thereof.

Embodiments can include one or more of the following features.

The article can have a first major surface and a second major surface opposing the first surface, wherein the styrene content of the first major surface is greater than the styrene content of the second major surface.

The polystyrene-b-poly(ethylene-co-butylene)-b-polystyrene can have a styrene content of between 25 wt % and 70 wt % (e.g., between 30 wt % and 45 wt %). For example, the polystyrene-b-poly(ethylene-co-butylene)-b-polystyrene can have has a styrene content of 42 wt %. In some embodiments, the polystyrene-b-poly(ethylene-co-butylene)-b-polystyrene is in a blend with polystyrene.

The predetermined structural feature can have a dimension of 50 nm to 500 μm. The article can include a plurality of predetermined features. The plurality of predetermined structural features can be arranged in an array. In some embodiments, the predetermined structural feature is a channel and the dimension is a channel width. In some embodiments, the predetermined structural feature is a well and the dimension is a width, length, or both the width and length. In some embodiments, the predetermined structural feature is a protrusion and the dimension is a protrusion width. In some embodiments, the predetermined structural feature is a protrusion and the dimension is a protrusion height. In some embodiments, the predetermined structural feature neither protrudes nor recesses into a surface of the article, but is instead a region on a surface of the article.

In some embodiments, the surface styrene content of the article is less than the bulk styrene content. In some embodiments, the surface styrene content is more than the bulk styrene content.

In some embodiments, the mold surface has a surface energy of 10 to 80 mJ/m². The mold can include a predetermined hydrophilic, hydrophobic, or hydrophilic and hydrophobic surface pattern. The mold can be reuseable.

Supplying the mold with polystyrene-b-poly(ethylene-co-butylene)-b-polystyrene can include solution casting, injection molding, or thermal embossing the polystyrene-b-poly(ethylene-co-butylene)-b-polystyrene in the mold.

In some embodiments, the method of making the article further includes the article to a substrate comprising glass or a polymer (e.g., a polystyrene).

Other features and advantages of the disclosure will be apparent from the following detailed description, and from the claims.

### DESCRIPTION OF THE DRAWINGS

FIGS. 1A-1D are schematic illustrations of representative embodiments of polymeric device surfaces.

FIG. 2A is a photograph of an embodiment of a polymeric device having a 50 μm-wide microchannel filled with dye.

FIG. 2B is an SEM image of an embodiment of a polymeric device having 8×2 μm (height×diameter) microposts with 7 μm spacing at 40°.

FIG. 3 is a graph showing contact angle measurements of embodiments of polymeric devices following oxygen plasma treatment for 5 min at a power 30 W and gas flow of 10 sccm. SEBS12 advancing (closed squares) and receding (open squares) angles and SEBS42 advancing (close circles) and receding (open circles) angles are shown. Error bars indicate ± one standard deviation. Advancing angles for PS and PDMS are also shown.

FIG. 4A is a graph showing 3T3 cell growth on embodiments of SEBS substrates.

FIG. 4B is a graph showing BPAEC cell growth on various SEBS substrates.

FIG. 5A is a photograph of an embodiment of a SEBS42 polymeric device showing the absorption of 100 μM rhodamine B in 50 μm wide channels.

FIG. 5B is a photograph of an embodiment of a PDMS polymeric device showing the absorption of 100 μM rhodamine B in 50 μm wide channels fabricated from SEBS42 and PDMS respectively.

FIG. 5C is a graph showing intensity profiles of the normalized fluorescence intensity of SEBS42 (solid line) and PDMS (dashed line) for FIGS. 5A and 5B, respectively. The intensity profiles are y-direction averaged and are normalized to the overall maximum and minimum intensity in each graph.

FIG. 5D is a photograph of an embodiment of a SEBS42 polymeric device showing little adsorption and leakage of rhodamine B from the channel after thorough rinsing with deionized water.

FIG. 5E is a photograph of an embodiment of a PDMS polymeric device showing adsorption and leakage of rhodamine B from the channel after thorough rinsing with deionized water.

FIG. 5F a graph showing intensity profiles of the normalized fluorescence intensity of SEBS42 (solid line) and PDMS (dashed line) for FIGS. 5D and 5E, respectively. The intensity profiles are y-direction averaged and are normalized to the overall maximum and minimum intensity in each graph.

FIG. 6 shows the UV-vis spectra of SEBS12, SEBS42, PS, and PDMS. All materials show transmittance near 100% down to approximately 400 nm (500-800 nm are not shown for clarity), with PDMS having improved transmittance below 350 nm. SEBS42 shows slightly higher transmittance than SEB12 and PS from 300-350 nm.

FIG. 7 is a graph showing advancing contact angles for embodiments of SEBS polymers.

### DETAILED DESCRIPTION OF THE INVENTION

Styrene-ethylene/butylene-styrene block copolymers, such as polystyrene-b-poly(ethylene-co-butylene)-b-polystyrene (“SEBS”) triblock copolymers, are thermoplastic elastomers that exhibit both glassy thermoplastic and elastomeric properties resulting from the hard polystyrene (“PS”) and rubbery poly(ethylene-co-butylene) fractions, respectively. SEBS block copolymers are tough, inexpensive, biocompatible, transparent, and chemically stable materials. Additionally, they are versatile, as properties such as mechanical stiffness and surface wettability can be altered by the composition of the block copolymer. The unique properties offered by SEBS copolymers make them well-suited for cellular biology micro/millifluidic applications. The present disclosure features the use of SEBS with higher PS content in polymeric devices, for example SEBS having 42 wt % PS (SEBS42), which has properties that are more comparable to pure PS than SEBS with lower PS content, for example 12 wt % PS (SEBS12). The SEBS copolymers with higher PS content have increased stiffness, a more hydrophilic surface, and greater PS surface coverage when compared with SEBS having lower PS content, while still retaining elastomeric properties that simplify the fabrication process and produce a more rugged device. The SEBS devices can be prepared via molding (e.g., micromolding) techniques. SEBS micro/millifluidic devices with increased PS content have the potential to be used in applications where hard thermoplastic materials are desired, such as cell culture studies that require low vapor and oxygen permeability, and can solve many of the difficulties associated with hard thermoplastic fabrication. Additionally, SEBS devices can perform similarly to PS when used in biological studies, can decrease the likelihood of experimental bias, and can maintain consistency between results obtained during micro/millifluidic studies with SEBS and biological studies performed on traditional PS substrates. The unique combination of surface and bulk properties of SEBS makes it a compelling material for use biological applications, such as micro/millifluidics, and in particular biology and cell-based micro/millifluidics. With the variety of SEBS commercially available, bulk mechanical and surface properties can be tailored to the specific needs of a study by varying the PS content in the SEBS and master mold surface functionality.

In some embodiments, SEBS with PS content greater than 20 wt % can be used in molds and stamps to make polymeric devices that have structural features of sub-micron resolution. In contrast to PDMS formulations, which can experience structure collapse with decreasing sub-micron structures due to its low modulus, the increased toughness and hardness of SEBS with PS content greater than 20 wt % render it well-suited for devices with sub-micron structures. SEBS with PS content greater than 20 wt % and increased stiffness can also provide dimensional stability to polymeric devices. SEBS stiffness and hardness can also be easily manipulated for specific applications by changing the ratio of the constituent polymer segments and/or the amount of ethylene or butylene units, or by blending with other polymers.

### Definitions

As used herein, the term “block copolymers” refers to a polymer formed of two or more covalently joined segments of polymers. The polymer segments can include copolymers, such as a copolymer of poly(ethylene-co-butylene).

As used herein, the term “copolymer” refers to a polymer that is the result of polymerization of two or more different monomers. The number and the nature of each constitutional unit can be separately controlled in a copolymer. The constitutional units can be disposed in a purely random, an alternating random, a regular alternating, a regular block, or a random block configuration unless expressly stated to be otherwise. A purely random configuration can, for example, be: x-x-y-z-x-y-y-z-y-z-z-z . . . or y-z-x-y-z-y-z-x-x . . . . An alternating random configuration can be: x-y-x-z-y-x-y-z-y-x-z . . . , and a regular alternating configuration can be: x-y-z-x-y-z-x-y-z . . . . A regular block configuration has the following general configuration: . . . x-x-x-y-y-y-z-z-z-x-x-x . . . , while a random block configuration has the general configuration: . . . x-x-x-z-z-x-x-y-y-y-y-z-z-z-x-x-z-z-z- . . . .

As used herein, SEBS copolymer refers to a triblock copolymer having an A-b-B-b-A structure, where A is polystyrene, B is poly(ethylene-co-butylene), b indicates block, and co indicates a copolymer (e.g., random copolymer). In some embodiments, the two polystyrene blocks A can have the same lengths. In certain embodiments, the two polystyrene blocks A can have different lengths.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Polymeric Devices

The present disclosure features polymeric devices formed, at least in part, of a polystyrene-b-poly(ethylene-co-butylene)-b-polystyrene having a polystyrene content of between 15 wt % and 70 wt %. The polystyrene-b-poly(ethylene-co-butylene)-b-polystyrene can have a composition that includes 15 wt % or greater (e.g., 20 wt % or greater, 25 wt % or greater, 30 wt % or greater, 35 wt % or greater, 40 wt % or greater, 50 wt % or greater) and/or 70 wt % or less (e.g., 50 wt % or less, 40 wt % or less, 35 wt % or less, 30 wt % or less, 25 wt % or less, or 20 wt % or less) of polystyrene. In some embodiments, the polystyrene-b-poly(ethylene-co-butylene)-b-polystyrene has between 25 wt % and 55 wt % polystyrene content (e.g., 42 wt % polystyrene, 35 wt % polystyrene). In some embodiments, the polymeric device includes blends of SEBS with PS homopolymers and can exhibit a wide range of material stiffness and elastomeric behaviors. The blend can have from 1 to 99 wt % SEBS (e.g., from 5 to 95 wt % SEBS, from 10 to 90 wt % SEBS, or from 20 to 80 wt % SEBS).

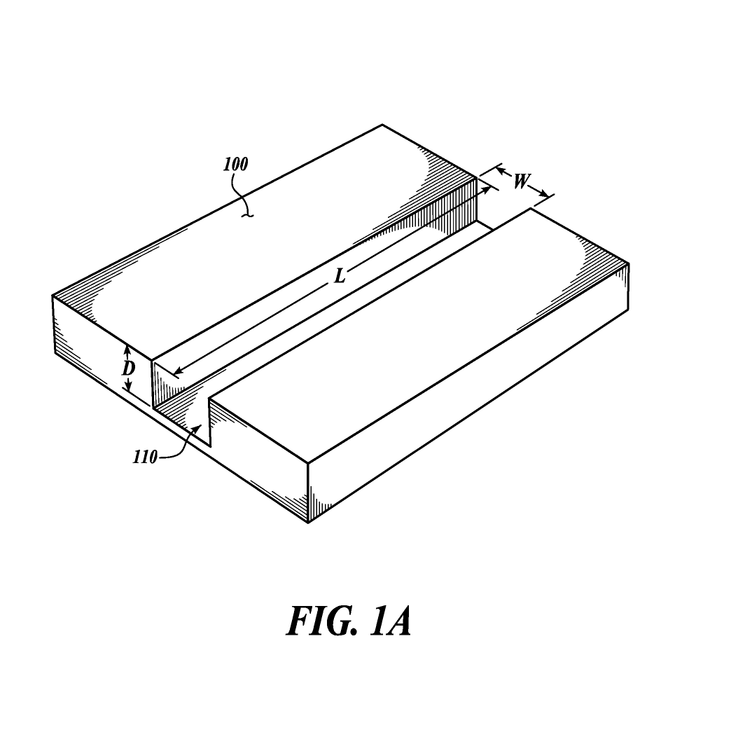

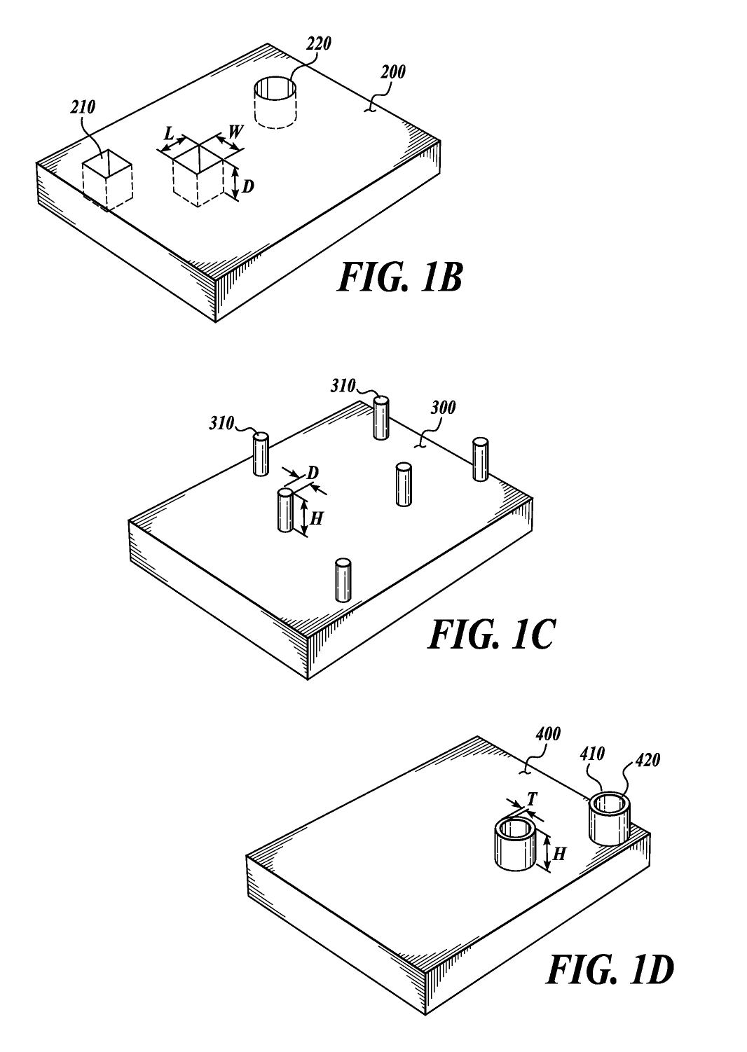

The polymeric devices have one or more structural features. The structural feature can take a variety of forms and can protrude out of or recess into a surface. For example, the structural features can include a channel, a pit, a well, a post, a ridge, a dimple, and/or a raised dot. The polymeric devices can have a repeating array of one or more features. In some embodiments, the structural features neither protrude nor are recessed relative to a surface, but are instead regions having different properties on the surface itself, such as regions having different surface energies, hydrophilicities, and/or hydrophobicities. The structural features can be regularly spaced relative to one another, or can be randomly distributed on a surface. The structural feature can have a dimension, such as a diameter, width, length, thickness and/or depth, of from 20 nm (e.g., from 50 nm, from 100 nm, from 500 nm, from 1 μm, from 500 μm, from 1 mm, or from 5 mm) to 1 cm (e.g., to 5 mm, to 1 mm, to 500 μm, to 1 μm, to 500 nm, to 100 nm, or 50 nm). For example, referring to FIG. 1A, representative polymeric device surface 100 includes channel 110, which can have a width W of from 20 nm to 5 mm, a length L of 5 mm to 250 cm, and a depth D of 500 nm to 1 mm. In some embodiments, referring to FIG. 1B, representative polymeric device surface 200 includes well 210 and/or pit 220. Well 210 can have a width of 100 nm to 5 mm, a length of 100 nm to 5 mm, and a depth of 500 nm to 1 mm. Pit 220 can have a diameter of 100 nm to 5 mm, and a depth of 500 nm to 1 mm. In some embodiments, referring to FIG. 1C, representative polymeric device surface 300 includes a protrusion 310 in the shape of a post or raised dot. The protrusion can have a diameter D of from 100 nm to 5 mm and a height H of from 500 nm to 1 mm. In some embodiments, referring to FIG. 1D, representative polymeric device surface 400 includes tubes 410 which include a wall 420, which can have a thickness T of from 500 nm to 1 mm, and a height of from 500 nm to 1 mm. In some embodiments, a ridge on a surface of a polymeric device can be relatively thin and can form a wall for a channel or a well. A ridge can have a thickness of from 500 nm to 1 mm, and a height of 500 nm to 1 mm. In addition to the geometry of the structural features shown, it will be appreciated that the features can have other shapes (e.g., nonrectangular channels, circular wells, rectangular posts, and rectangular ridges).

The polymeric device can have relatively large ratio of width and length compared to height. In some embodiments, the ratio of width and/or length to height is 100 or more (e.g., 1,000 or more, 10,000 or more, or 100,000 or more) and/or 1,000,000 or less (e.g., 100,000 or less, 10,000 or less, or 1,000 or less). The polymeric device can have a first major surface, defined as the width by length on one side of the polymeric device, and a second major surface defined as the width by length on a second side of the polymeric device that is on an opposite side of the first major surface. For example, the polymeric device can be in the form of a sheet having a first major surface facing up and a second major surface opposite to the first sheet that faces down.

The surface of the polymeric device can control interaction between the polymeric device's structural features and a biological or solution environment that comes into contact with the polymeric device. The physical and chemical interactions based upon the first few nanometers of the polymeric device's surface can determine properties such as adhesion, wetting, and corrosion, which influence many biological applications. For biological micro/millifluidic applications with SEBS, polymeric device that maximize the PS content at the surface can be advantageous. Generally, preferential wetting of one segment of the block copolymer at the surface can be controlled by the relative surface energies.

In some embodiments, the polymeric device has a surface polystyrene concentration that is different (e.g., greater or less) than a distribution of polystyrene in the bulk. In some embodiments, the polymeric device has a polystyrene concentration in a first surface that is different (e.g., greater or less) compared to a polystyrene concentration in a second surface that is adjacent or on an opposite side to the first surface. In some embodiments, the polymeric device can have a polystyrene concentration in a first region of a surface that is different (e.g., greater or less) compared to a second region of the same surface. For example, the polymeric device can have a polystyrene concentration on a surface that is greater or less by 5 wt % or more (e.g., 10 wt % or more, 15 wt % or more, 25 wt % or more, or 50 wt % or more) and/or 75 wt % or less (e.g., 50 wt % or less, 25 wt % or less, 15 wt % or less, or 10 wt % or less) than the polystyrene concentration in the bulk, on a different surface, or on a different region of the surface of the polymeric device. As used herein, “surface” refers to a layer having a depth of 1-10 nm proximal to the topmost portion of a polymeric device. As used herein, “region” refers to a portion of the surface. The relative surface composition of the PS at different surfaces can be determined using time-of-flight secondary ion mass spectrometry (ToF-SIMS). ToF-SIMS can offers advantages such as surface sensitivity and high molecular specificity In some embodiments, the polymeric device has a surface wettability of from 20 mJ/cm² to 40 mJ/cm², depending on the polystyrene concentration. For example, a surface with a wettability of 20 mJ/cm² can have a PS surface concentration of less than 1 wt %; a surface with a wettability of 30 mJ/cm² can have a PS surface concentration of about 20 wt %. Surface wettability can be calculated from contact angle measurements and theory, as described in, Hansen F. K., Measurement of surface energy of polymers by means of contact angles of liquids on solid surfaces, University of Oslo, 2004, herein incorporated by reference in its entirety.

In some embodiments, the polymeric device has a zeta potential of from −50 to −80 mV, depending on the polystyrene concentration. For example, a surface zeta potential of −50 mV can correlate with a surface having less than 1 wt % PS concentration. A surface zeta potential of −70 mV can correlate with a surface having about 20 wt % PS concentration. Zeta potential measurements of microfluidic substrates are described, for example, in Kirby et al., Electrophoresis, 2004, 25(2), 187-202, herein incorporated by reference in its entirety.

In some embodiments, the polymeric device has a contact angle value of from 90 to 110°, depending on the polystyrene concentration. For example, a contact angle of 110° can correlate with a surface having less than 1 wt % PS concentration. A contact angle of 95° can correlate with a surface having about 20 wt % PS concentration. Contact angle can be measured using a contact angle goniometer and a drop and/or tilting plate method.

### Applications of the Polymeric Device

The polymeric devices can include laboratory plasticware, such as multi-well PCR plates, sealing films, dishes, and flasks. Representative polymeric devices can include cell culture plasticware such as dishes, flasks, high throughput cell plasticware, centrifuge tubes, tissue culture plates, cell culture inserts, cryogenic vials, roller bottles, and microarray slides. The polymeric devices can be microfluidic or millifluidic devices. The polymeric device can be micro total analysis systems (μTAS) or biomedical analyte diagnostic devices. The shapes, density, and surface properties (e.g., hydrophobicity) of the structural features on the polymeric devices can be tailored to favorably interact with tissues and cells. The polymeric devices can facilitate fluid manipulation, detection of low analyte levels, detection of cellular organisms, and manipulation of cells compared to polystyrene devices. The polymeric devices can provide a good surface for cell adhesion and proliferation, and can be resistant to fluid leakage and small molecule adsorption.

### Method of Making the Polymeric Device

The polymeric device can be made using a variety of methods, such as solution casting, injection molding, or thermal embossing a SEBS copolymer, or a blend of SEBS copolymer and PS in a mold, setting the SEBS copolymer to provide the polymeric device, then removing the polymeric device from the mold by, for example, peeling the polymeric device from the mold.

A variety of SEBS copolymers suitable for use in making the polymeric devices can be obtained from commercial sources, such as from Kraton Performance Polymers Inc., Asahi Kasei Chemicals, and Dynasol. For example, 12-58 PS wt % SEBS is available from Kraton Performance Polymers Inc., and 12-67 PS wt % SEBS is available, for example, from Asahi Kasei Chemicals.

The mold can have a predetermined structural feature imprint that transfers to a molded polymeric device. The mold can be reusable and can be made from a variety of materials, such as steel, silicon, glass, and polymer materials. The structural feature imprint can be formed in the mold by micromilling, laser etching, chemical etching, micromolding, and 3-D printing.

The mold can also have surface properties that can influence the concentration of polystyrene at the mold-polymeric device interface. For example, the wetting properties at the mold-SEBS copolymer interface can influence the surface of a resulting SEBS polymeric device. Polyethylene (PE) and polybutylene (PB) have lower free energies than PS and can thus preferentially can segregate to the polymer/air interface at equilibrium, but the composition of the polymer-mold interface is dependent upon the functionality of the mold surface and its respective interaction with the PS and poly(ethylene-co-butylene) blocks of a given SEBS copolymer. The fraction of each polymer block segment in the SEBS copolymer (and the resultant morphology) can also affect the segregation and structure of the copolymer at the surface.

In some embodiments, the mold has a surface that is hydrophilic, hydrophobic, or a combination thereof, configured to contact a SEBS copolymer. The mold can have regions of hydrophobic and hydrophobic surfaces that can form a pattern. In some embodiments, the mold has a photoresist-coated surface, a silicon surface, or a silane-functionalized silicon surface. Photoresist coatings can include, for example, polymers such as SU-8. Silanes that are are suitable for treating the silicon surface can include, for example, chlorosilanes, methoxysilanes, and/or ethoxysilane. Representative silanes can include, for example, trichloro(octyl)silane, trichloro(octadecyl)silane, trichloro(hexyl)silane, trichloro(phenyl)silane, trichloro(phenethyl)silane, and trichloro(1H,1H,2H,2H-perfluorooctyl)silane. A variety of silanizing agents are available, for example, from Sigma Aldrich Co. LLC. In some embodiments, the mold surface configured to contact the SEBS copolymer has a surface energy of 10 to 80 mJ/m². A mold surface having a surface energy of 45 mJ/m² or greater is hydrophilic, and a mold surface having a surface energy of less than 45 mJ/m² is hydrophobic, with respect to SEBS.

A mold having a more hydrophobic surface is likely to result in a polymeric device having less polystyrene at the device surface in contact with the mold. In contrast, a mold having more hydrophilic surface is likely to result in a polymeric device having more polystyrene at the device surface. Without wishing to be bound by theory, it is believed that polystyrene is a more hydrophilic block in SEBS copolymers, when compared to poly(ethylene-co-butylene). When in contact with a mold having a hydrophilic surface, hydrophilic polystyrene blocks are preferentially drawn to the mold interface during setting of a SEBS copolymer, as the SEBS copolymer organizes In contrast, when in contact with a mold having a hydrophobic surface, hydrophobic poly(ethylene-co-butylene) blocks are preferentially drawn to the mold interface during setting of a SEBS copolymer, as the SEBS copolymer organizes

In some embodiments, the polystyrene surface concentration of a polymeric device can depend upon the polystyrene content of a given SEBS polymer that forms the polymeric device. A SEBS copolymer having a 15 wt % polystyrene content may result in little difference in polystyrene content at a surface of a polymeric device compared to a bulk of the polymeric device, as there is a small proportion of polystyrene in the starting polymer to result in observable segregation of the polystyrene blocks. However, a SEBS copolymer with an intermediate amount of polystyrene, such as 30 wt % to 50 wt %, can result in observable differences in the polystyrene content at a polymeric device surface compared to the bulk of the polymeric device.

In some embodiments, setting the SEBS copolymer includes evaporating a solvent in which the SEBS copolymer is dissolved. The evaporation can occur in one or more stages and/or at one or more temperatures. Suitable solvents for SEBS copolymer include aromatic and aliphatic solvents having a Hildebrand/Hansen solubility factor in the range of approximately 14-20 MPa^{1/2} or 6.8-9.8 cal^{1/2}. In some embodiments, suitable solvents for SEBS copolymer include high boiling point solvents such as toluene, 1,2,4-trimethylbenzene, and mesitylene. In some embodiments, setting the SEBS copolymer includes solidifying a SEBS copolymer over a sufficient amount of time and/or under controlled temperature conditions so that the copolymer can phase segregate or otherwise undergo rearrangement with respect to a mold's surface properties. For example, setting a

SEBS copolymer that is dissolved in a solvent can include slowly evaporating the solvent at a temperature of between 40 and 95% of the normal boiling point of the solvent for at least 4 hours and up to 24 hours. SEBS phase segregation is described, for example, in Thomann et al., Appl. Phys. A 66:S1233-S1236 (1998) and Wang et al., Polymer 49:2153-2159 (2008).

In some embodiments, the polymeric devices can be affixed to PS, SEBS, or glass substrates to provide a final device by, for example, thermal bonding, pressure bonding, solvent bonding, bonding using chemical surface modification (e.g. oxygen plasma), or adhesive bonding (e.g., using double sided tape, epoxy, or glue) the polymeric device to the substrate.

The following examples are provided for the purpose of illustrating, not limiting, the invention.

### EXAMPLES

### Example 1

### Benchtop Replica Micromolding of SEBS

A simple micromolding technique that only requires the use of basic lab equipment (hot plate and desiccator) and a common organic solvent is presented. SEBS with higher PS content, for example 42 wt % PS (SEBS42), was used. SEBS42 possesses properties that are more comparable to pure PS than SEBS with lower PS content, for example 12 wt % PS (SEBS12). These properties include increased stiffness, a more hydrophilic surface, and greater PS surface coverage, while still retaining elastomeric properties that simplify the fabrication process and produce a more rugged device.

A facile microfabrication method, as well as the surface composition, contact angle, cell culture growth, UV-vis and autofluorescence spectra, hydrophobic molecule adsorption and absorptions, and mechanical properties of SEBS, are shown, to demonstrate the applicability of SEBS for micro/millifluidic research studies.

High-fidelity SEBS micro/millifluidic devices with high PS content (e.g., 42 wt % PS) and low PS content (e.g., 12 wt % PS), can be rapidly and reproducibly made using molding techniques, such as a soft lithography micromolding technique. The elastomeric properties of SEBS facilitate molding, bonding, and interfacing of micro- or milli-devices and can offer a simple alternative to PS micro/millifluidics. The bulk optical and mechanical properties of SEBS were also measured. Overall, SEBS copolymers possess properties that are well suited for biological lab-on-a-chip devices that make them suitable to replace current thermoplastic and elastomeric materials used for these applications.

SEBS block copolymers (Kraton Polymer) with 42 wt % (A1536H) and 12.5 wt % (G1645M) polystyrene were utilized as polymers for molded microfluidic devices. The 42 and 12 wt % block copolymers are referred to hereafter as SEBS42 and SEBS12, respectively. Toluene (99.8%, CAS# 108-88-3), rhodamine B (95%, CAS# 81-88-3), trichloro(1H,1H,2H,2H-perfluorooctyl) silane (97%, CAS# 78560-45-9), polystyrene (avg. Mw ˜192,000), 1,2,4-trimethylbenzene (98%, CAS# 95-63-6), and HEPES (CAS# 7365-45-9) were obtained from Sigma Aldrich (St. Louis, Mo.) and used as received. For the cell growth studies, human fibronectin solution (BD Biosciences), high glucose Dulbecco's modified Eagle's medium (SH30022.01, Thermo Scientific), 10% fetal bovine serum SH3981993, Thermo Scientific), and 1% penicillin-streptomycin (30-002-CI, Mediatech) were used. SU8 2000 photoresists (MicroChem Corp, Newton, Mass.) and silicon wafers (Silicon Quest International, Inc., Santa Barbara, Calif.) were utilized to generate the master mold via photolithography. Sylgard 184 PDMS (Down Corning, Midland, Mich.) was used as a comparison material to SEBS and was prepared using the silicone elastomer kit.

Master mold fabrication. Three different master substrates were fabricated to investigate the effect of the substrate on the polymer surface composition: SU-8 coated, silane-treated, and untreated silicon. SU-8 coated wafers were fabricated in a two-step process so that all the surfaces in contact with the SEBS would be uniformly SU-8. First, an initial layer of photoresist 5-5 10 microns thick was spincoated on a 4″ silicon wafer and then pre-baked for 1-3 minutes at 95° C. A contact aligner uniformly exposed the first SU-8 layer without a photomask. The exposed wafer was baked for 2-4 minutes at 95° C. The second lithography step was standard SU-8 microstructure fabrication. An SU-8 photoresist layer 25-100 microns thick was spun on top of the initial SU-8 coating and prebaked. The resist was then exposed to UV-light through a printed photomask using an ABM contact aligner, baked again, developed using Microchem SU-8 developer, and then hard baked for 3 h at 150° C.

Molds indicated as untreated silicon were fabricated using the SU-8 coated process described above without the initial uniform SU-8 layer. Molds indicated as silane are the same as the untreated silicon with an additional trichloro(1H,1H,2H,2H-perfluorooctyl)silane treatment by vapor deposition at ambient conditions in a sealed container.

Replica molding (e.g., micromolding) and device fabrication. SEBS42 and SEBS12 were dissolved in toluene at 20-30 wt % solids. The high viscosity at >30 wt % solutions often resulted in significant surface bubble formation during casting. Following dissolution of the solid, the solutions are de-gassed under vacuum for 15 min before casting onto the master molds. The solution is retained on the mold using a PTFE coated metallic ring that surrounds the wafer. The SEBS molded sample was baked in a two-step process at 45° C. for 5 h and 95° C. for 10 h using a hotplate in a fume hood. Following baking, the SEBS was gently peeled from the mold and soaked in deionized (“DI”) water for 30 min to remove any residual solvent. If a lower vapor pressure solvent is desired for reduction of surface bubbles during casting, 1,2,4-trimethylbenzene (b.p.=168° C.) can be used in place of toluene. Recommended baking conditions for 1,2,4-trimethylbenzene are 140° C. for 10 h. All data presented herein utilized toluene as the casting solvent.

For bonding of SEBS to substrates such as glass, PS, and other SEBS, oxygen plasma treatment and/or heating were used to ensure uniform interfacial contact. Reversible bonding to PS or other SEBS substrates was achieved using plasma oxidation treatment on both surfaces to be bonded with a Harrick Plasma Cleaner (PDC-001, Ithaca, N.Y.) for 5 min at 30 W and a flow of 10 sccm O₂. For a stronger, irreversible bond, the substrates were placed into contact and baked at 65° C. for 30-60 min, followed by firmly pressing the two substrates together. Quality bonding to glass was not achievable without the use of thermal bonding. No deformation of the structural features when bonding thermally to PS, SEBS, or glass was observed. The maximum pressure that SEBS42 bonded to SEBS42 could withstand with no treatment, oxygen plasma treatment, and following annealing at 75° C. was measured. The maximum pressure that SEBS42 thermally bonded to glass and PS could withstand was also measured. Small PS cylindrical wells were attached to the SEBS surface with epoxy and filled with colored water. The fluid was pressurized using argon gas and pressure was increased until fluid leaked from the channel. The connection to the devices failed at pressures greater than 60 psi.

Methods to assess SEBS properties and performance. Both physical properties (surface composition, contact angle, elastic modulus, UV-vis transmission, and autofluorescence) and performance in micro/millifluidic applications of the SEBS substrates were evaluated. SEBS was also tested as a cell culture substrate and its permeability to a hydrophobic fluorescent dye was assessed.

### Cell Culture

SEBS42 substrates for cell culture were made by casting on flat silicon wafers coated with a thin layer of SU-8. The four different sets of SEBS substrates are: native SEBS, SEBS treated with ozone for 7 minutes in a UVO Cleaner (Jelight), SEBS with human fibronectin (FN) solution (50 μg/ml, BD Biosciences) adsorbed to the surface for 1 h, and SEBS treated with ozone followed by adsorption of FN. PDMS substrates were prepared by adsorbing the same concentration of FN onto the surface. All substrates were rinsed in 100% ethanol, followed by 70% ethanol and sterile deionized water before being placed into wells of a 6-well tissue culture dish (657160, Greiner Bio-one). Cell culture media consisting of high glucose Dulbecco's modified Eagle's medium (SH30022.01, Thermo Scientific), 10% fetal bovine serum (SH3981993, Thermo Scientific), and 1% penicillin-streptomycin (30-002-CI, Mediatech) were added to each well and incubated for 20 minutes prior to seeding mouse 3T3 fibroblast cells (NIH 3T3 fibroblasts, from C. Chen, University of Pennsylvania) or bovine pulmonary arterial endothelial cells (bPAECs, BW-6004, Lonza) onto the substrates. Media was exchanged on days 2, 4, and 6. On days 2, 4, 6, and 9, a group of substrates were removed from the incubator and the cells were fixed in a solution of 4% paraformaldehyde. The cells were permeabilized and stained using 0.2% Triton X-100 and Hoesch 33342 (H1399, Invitrogen), respectively. The cells were mounted with coverslips using Fluoromount G (0100-01, Southern Biotech) before fluorescent imaging of the cells at the center and each corner of each substrate using a Nikon Eclipse TI inverted microscope and a 10× objective. The number of cells in each image were counted using Nikon Elements analysis software.

Analysis of Variance (ANOVA) with equal replication statistical tests was used to analyze the differences in cell growth on the various substrates for day 2, 4, 6, and 9. Tukey-Kramer comparison of means tests determined the statistical differences between samples. All statistical results were reported at 95% confidence intervals (α=0.05).

### Contact Angle

Advancing and receding water contact angle measurements were performed with a goniometer (Rame-Hart Instrument Co., Netcong, N.J.) using a dynamic sessile drop method on flat substrates of SEBS42 and SEBS12. The substrates were cast from flat silicon wafers coated with a thin layer of SU-8 and oxidized (Harrick Plasma Cleaner PDC-001, Ithaca, N.Y.) for 5 min at 30 W and a flow of 10 sccm (standard cubic centimeters per minute) O₂ following casting. Measurements were made on the native surface that did not receive any treatment following casting. The advancing and receding angles correspond to constant angle measurements for increasing and decreasing drop volume, respectively. Each angle measurement is the average of five drops on three different samples for both SEBS42 and SEBS12 with standard deviations reported.

### TOF-SIMS

Time of flight secondary ion mass spectrometry (TOF-SIMS) spectra of SEBS42 and SEBS12 samples were acquired on a Ion TOF-SIMS 5-100 spectrometer using a 25 keV Bi³⁺ cluster ion source in the pulsed mode. SEBS42 and SEBS12 were cast on silicon wafers coated with a thin layer of SU-8, silicon wafers treated with silane, and untreated silicon wafers. Small square samples (1 mm×1 mm) were prepared and rinsed thoroughly with isopropyl alcohol, ethanol, and DI water. TOF-SIMS spectra were acquired for both positive and negative secondary ions over a mass range of m/z=0 to 700. The ion source was operated at a current of 0.14 pA. The secondary ion dose was kept below 5×10¹¹ ions/cm². Secondary ions of a given polarity were extracted and detected using a reflectron time-of-flight mass analyzer. Spectra were acquired using an analysis area of 100×100 μm. Positive ion spectra were calibrated using the CH₃⁺, C₂H₃⁺, C₃H₅⁺, and C₈H₇⁺ peaks. The negative ion spectra were calibrated using the CH⁻, OH⁻, C₂H⁻ peaks. Calibration errors were kept below 10 ppm. Mass resolution (m/Δm) for a typical spectrum was 4500 to 5200 for m/z=27 (positive) and 5500 to 6500 for m/z=25 (negative).

### Dye Adsorption and Absorption

Simple dye adsorption and absorption measurements for SEBS and PDMS devices were performed with microfluidic channels (50 μm width, 30 μm depth) filled with 100 μM rhodamine B (81-88-3, Sigma Aldrich, St. Louis, Mo.) solution for 15 minutes. An inverted epi-fluorescence microscope (Nikon TE2000, Melville, N.Y.), a fluorescent optical filter set (XF108-2, Omega, Brattleboro, Vt.), 10× objective, and cooled digital camera (Cascade IIb, Photometrics, Tuscon, Ariz.) imaged the rhodamine dye in the microchannel. The channels were thoroughly rinsed with DI water and re-imaged approximately 15 minutes after initial imaging.

### Optical Properties

The substrate transmissibility was determined using a UV/vis/NIR spectrometer (Lambda 1050, PerkinElmer, Waltham, Mass.) equipped with an integrating sphere measures the optical spectra of 1 mm thick, 1″×1″ samples. The auto-fluorescence of SEBS42 formed to the shape of a standard 3.5 mL cuvette was determined using a luminescence spectrometer (LS55, PerkinElmer, Waltham, Mass.). The samples were excited from 200-800 nm in 10 nm intervals, while recording emission scans from 200-800 nm for each excitation wavelength. The SEBS42 is compared to the spectra of a polystyrene fluorometer cuvette (cat# 9012, Perfector Science, Atascadero, Calif.) with the same experimental setup.

### Mechanical Properties

The mechanical testing was conducted according to the ASTM standard D638-10. 1-1.5 mm thick SEBS samples were molded according to Type IV dimensions, with a gauge length and thickness of 25 mm and 6 mm respectively. The tensile tests were performed using an Instron high load frame (5585H, Instron, Los Angeles, Calif.) at a speed of 2 mm/min under ambient conditions. The stress-strain curves were recorded using a static axial extensometer (cat# 2630-106, Instron, Los Angeles, Calif.) for a minimum of five replicates for each sample. The modulus of elasticity is reported as the linear response of the stress-strain curve.

### Zeta Potential Measurements

The zeta potential of SEBS42 was measured. Microchannels 200 μm wide, 60 μm tall, and 7 mm in length were fabricated by casting on all SU-8 wafers. The microchannel ports were punched using a flattened syringe needle, thermally bonded at 65° C. to a flat SEBS substrate, and glass wells were attached using UV-curable epoxy. The channel was thoroughly washed with 100 mM NaOH, DI water, and 9 mM KCl before monitoring. One well and the channel were filled with 9 mM KCl, while the other well was filled with 10 mM KCl. A potential difference of 200V was applied via platinum electrodes placed into each well using a remote source meter (Keithley 6430, Cleveland, Ohio) and the change in current with respect to time was monitored using a custom-made Labview interface. The zeta potential was calculated using the slope of the current-time plot and the Smoluchowski equation, as previously reported by Sze et al., Journal of Colloid and Interface Science, 2003, 261:402-410, incorporated herein by reference in its entirety. The bulk conductivities of the KCl solutions were measured using a high-precision conductivity meter. The 9 mM KCl solution measures kb=1091 μS cm⁻¹ and the 10 mM KCl measures kb=941 μS cm⁻¹. At least five measurements were made on a microdevice each day over the course of a week.

### Device Fabrication

Structural features are replicated by pouring dissolved SEBS onto an SU-8 master mold, followed by a two-step baking process. The amount of solution added is dependent upon the desired thickness of the polymeric devices, with molds (e.g., micromolds) ranging from ˜0.1 mm to 5 mm thick easily fabricated. The initial low temperature baking step at 45° C. is to remove a majority of the solvent well below the boiling point of toluene (110.6° C.), while the second step at 95° C. ensures complete removal of the solvent. Repeatable, high fidelity structural feature (e.g., microstructure) replication can be produced with this molding process.

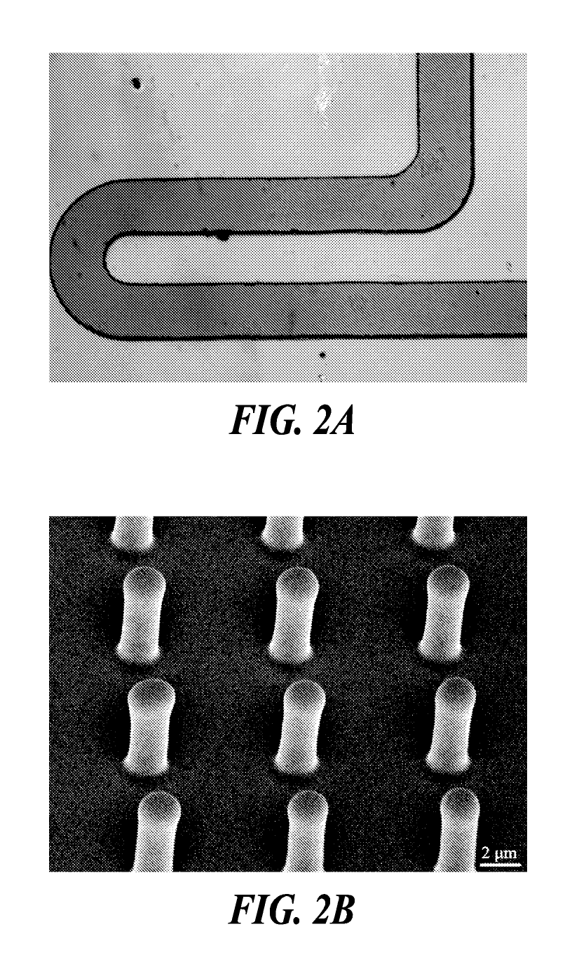

FIG. 2A illustrates replication of 50 μm wide microchannels and FIG. 2B illustrates microposts with a 4:1 aspect ratio and 7 μm spacing. Microstructures as small as 2 μm have been successfully replicated. The compliance of the SEBS also allows it to be easily peeled from rigid mold surfaces during de-molding, while maintaining feature integrity.

Silane treatment of the master mold assists in release of the SEBS and preserves the structural features during repeated castings, although the silane can impact the SEBS device surface composition. Casting on a silicon wafer with SU-8 structural features (e.g., microstructures) and no surface treatment led to more difficulty in removing the SEBS from the mold and resultant structural feature damage as early as the initial casting. Applying a thin coating of SU-8 to the silicon wafer before fabricating the structural features however, results in a stronger adhesion of SU-8 structural features and provides improved release in comparison to SU-8 on untreated silicon wafers. This route also produces more PS surface functionality than silane treated wafers. Silane treated wafers could be used >25 times on average without any noticeable defects, while all SU-8 wafers could be used >15 times on average.

Bonding and access port interfacing is easily achieved in SEBS materials with rounded punches similar to protocols for PDMS. This methodology greatly simplifies the fabrication process when compared to hard thermoplastics. Molded SEBS can be reversibly or irreversibly bonded to a number of substrates including PS, SEBS, and glass. Reversible bonding of SEBS to PS or SEBS is facilitated by oxygen plasma treatment of the two surfaces to be bonded, but simply firmly pressing the two substrates together at room temperature without treatment provides some bonding; however, this is weaker than the plasma bond. Irreversible bonding can be achieved through heating at 65° C. while the surfaces are in intimate contact, followed by manual pressure. Effective bonding to glass is possible with this thermal treatment. The irreversible bonding of SEBS to PS, glass, and other SEBS did not rupture when a dead-ended channel was pressurized using a 5 mL syringe pump, suggesting that the sealing should be satisfactory for the majority of low to moderate pressure micro/millifluidic applications.

The modulus of elasticity of SEBS42 and SEBS12 was determined to be 6.18±0.29 MPa and 0.86±0.12 MPa respectively. The increase in PS content in SEBS42 results in a stiffness 2-6× greater than standard 10:1 ratio Sylgard 184 PDMS and SEBS with 10-15 wt % PS.

### Surface Composition

Approximate interaction strengths between the polymer and substrate surface was calculated in an effort to predict the affinity of PS to preferentially segregate to the silicon, SU-8, and silane treated silicon surfaces. The interaction strength can be calculated by considering the work of adhesion, W₁₂ that is required to separate two surfaces. This technique has successfully been used to predict the adsorption of different block polymers to cellulose substrates using molecular modeling to obtain energy values over a specified area. See, e.g., Chauve et al., Biomacromolecules, 2005, 6:2025-2031, and Li et al., ACS Applied Materials & Interfaces, 2011, 3, 2349-2357. The work of adhesion is calculated by applying the same technique using surface free energies and interfacial tensions, given as,

W₁₂=−(γ_{polymer-substrate}−γ_{polymer}−γ_{substrate}) (1)

where γ_{polymer} and γ_{substrate} are the surface free energies of the polymer and surface respectively and γ_{polymer} substrate is the interfacial tension between the polymer and substrate. The interfacial tension for a polymer system is adequately predicted by the harmonic mean equation,

$${γ}_{12} = {γ}_{1} + {γ}_{2} - \frac{4 {γ}_{1}^{d} {γ}_{2}^{d}}{{γ}_{1}^{d} + {γ}_{2}^{d}} - \frac{4 {γ}_{1}^{p} {γ}_{2}^{p}}{{γ}_{1}^{p} + {γ}_{2}^{p}} , \qquad ( 2 )$$

where the subscripts 1 and 2 refer to the two individual phases; γ^{d} and γ^{p} correspond to the dispersion and polar components that respectively account for the dispersion force and various dipolar/specific interactions. The dispersion and polar components can be determined through contact angle goniometry measurements. The calculated W₁₂ values are shown in Table 1.

TABLE 1

| Surface | Polymer | W₁₂ (mJ/m²) | ΔW₁₂ (mJ/m²) |
|---|---|---|---|
| SU-8 | PS | 64.1 | 12.6 |
| | PEB | 51.5 | |
| Silane | PS | 37.0 | 1.5 |
| | PEB | 35.5 | |
| Silicon | PS | 85.8 | 24.5 |
| | PEB | 61.3 | |

Positive W₁₂ values indicate attractive forces, with larger values corresponding to a larger amount of work being required to separate two surfaces, demonstrating greater attraction through dispersion and specific interactions. The net work of adhesion of the different blocks to the surface,

ΔW₁₂=(W_{PS-surface}−W_{PEB-surface}) (3)

is calculated in order to see the differences between the polymer block's affinity for each surface. When ΔW₁₂ is large, there is a preferential interaction of one block component with the substrate. The large PS ΔW₁₂ for silicon and SU-8 in Table 1 indicate that PS should be more attracted to these surfaces than the highly hydrophobic silane surface. The work of adhesion is also an important consideration when taking into account de-molding of the SEBS. Lower W₁₂ values indicate less force required to de-mold the SEBS and thus help to preserve the integrity of the master molds. The low W₁₂ values for silane make sense given that silane is often used as a mold release agent. Conversely, the high surface free energy of silicon wafers results in more difficult de-molding of SEBS, and thus greater likelihood of destruction of structural features during de-molding. The intermediate value of SU-8 allows for improved de-molding over silicon, but with more mold degradation than the silane treated surface.

The relative surface composition of the PS at different substrate surfaces was determined using time-of-flight secondary ion mass spectrometry (TOF-SIMS). Semi-quantitative data trends for surface composition using principal component analysis (PCA) and approximate surface concentrations is presented. Surface spectra of SEBS42 and SEBS12 cast on SU-8 and silane treated surfaces and SEBS42 on untreated silicon wafers are analyzed by static TOF-SIMS using the NESAC/BIO toolbox to run multivariate principle component analysis (PCA) for comparison of the different samples. PCA is a powerful tool that utilizes the entire peak spectrum in order to identify the major sources of differences within and between samples. It generates two important matrices: the scores, which show the relationships between the samples for a given principal component and the loadings, which specify the variables (peaks) that are responsible for the separation seen in the scores plot.

Table 2 lists the scores of the PCA analysis for principal component 1. The scores are a semi-quantitative comparison of PS content, as samples with more negative scores have greater PS content at the surface than samples with more positive scores. For the same casting surface, SEBS42 exhibits more negative scores relative to SEBS12, suggesting higher surface PS content as might be expected for the larger PS content in the block copolymer. Furthermore, the data shows that more PS is present on the surface when the SEBS is cast on SU-8 or silicon compared to silane treated wafers. More PS is at the surface because of the greater attractive forces between PS and SU-8 or silicon, which agree qualitatively with the work of adhesion calculations. The results of the PCA analysis can be compared to quantitative calculations with the use of characteristic ion peaks. Quantitative analysis of block copolymer segregation to interfaces has been reported previously using the relative intensity of characteristic ion peaks to quantify molar surface composition. See, e.g., L. T. Weng, P. Betrand, W. Lauer, R. Zimmer, and Busetti, S., Surface and Interface Analysis, 1995, 23:879-886; S. Liu, L.-T. Weng, C.-M. Chan, L. Li, N. K. Ho, and M. Jiang, Surface and Interface Analysis, 2001, 31:745-753; S. Liu, C.-M. Chan, L.-T. Weng, and M. Jiang, Analytical Chemistry, 2004, 76:5165-5171. The molar fraction of PS at the surface can be defined by,

$$R = \frac{{I}_{PS}}{{I}_{PS} + {I}_{PEB}} \qquad ( 4 )$$

where I_{PS} and I_{PEB} are the total intensities of the characteristic ions from PS and PEB respectively. Table 2 shows the molar fraction of PS at the surface for SEBS42 and SEBS12 at the various substrate surfaces. The peaks chosen to calculate the fractions in

Table 2 are the characteristic peaks for each polymer block that are least affected by matrix effects. SEBS42 cast on SU-8 has approximately 25% PS at the surface, while SEBS12 cast on SU-8 has approximately 4% PS at the surface. SEBS42 cast on silane has approximately 15% PS at the surface, while SEBS12 cast on silane has less than 2% PS at the surface. SEBS42 cast on silicon results in the maximum amount of PS with 36% PS at the surface. The large standard deviations indicate the uncertainty of the quantitative results, but overall, the trends match well with the PCA results that utilize the entire spectrum and are much less sensitive to matrix effects.

TABLE 2

| | | | | Average surface | |
|---|---|---|---|---|---|
| Surface | Polymer | Score | | concentration | |
| SU-8 | SEBS42 | −6.7 | (±1.3) | 25.5 | (±8.1) |
| | SEBS12 | 28.9 | (±1.7) | 3.74 | (±1.21) |
| | PS | −39.8 | (±2.1) | 85.9 | (±5.1) |
| Silane | SEBS42 | 0.34 | (±0.58) | 15.9 | (±6.5) |
| | SEBS12 | 31.0 | (±3.5) | 2.38 | (±0.76) |
| Silicon | SEBS42 | −13.7 | (±0.46) | 36.6 | (±9.4) |

Collectively, the SIMS results indicate that the surface-polymer interactions, as well as the fraction of PS in the copolymer affect the amount of PS at the surface. SEBS42 has significantly more PS at the surface than SEBS12 on all surfaces. Silicon casting substrates result in the most PS at the surface, followed by SU-8 and then silane surfaces. However, the trade-off with practical usefulness in regards to master mold integrity (i.e., silane molds experience very little degradation and silicon molds result in microstructure removal) must also be considered.

### Surface Properties

The native surface of both SEBS42 and SEBS12 cast on SU-8 are marginally hydrophobic, exhibiting advancing water contact angles greater than 90°. The advancing angles for SEBS42 and SEBS12 are 95.9°±2.3° and 113.0±1.8° respectively, while the receding angles are 71.0±2.5° and 73.7°±2.1° . PS has an advancing contact angle of 91-94°, while PE and PB have advancing contact angles of 97 and 112° respectively. The larger advancing contact angle for SEBS12 can be attributed to a higher concentration of the more hydrophobic PEB at the surface.

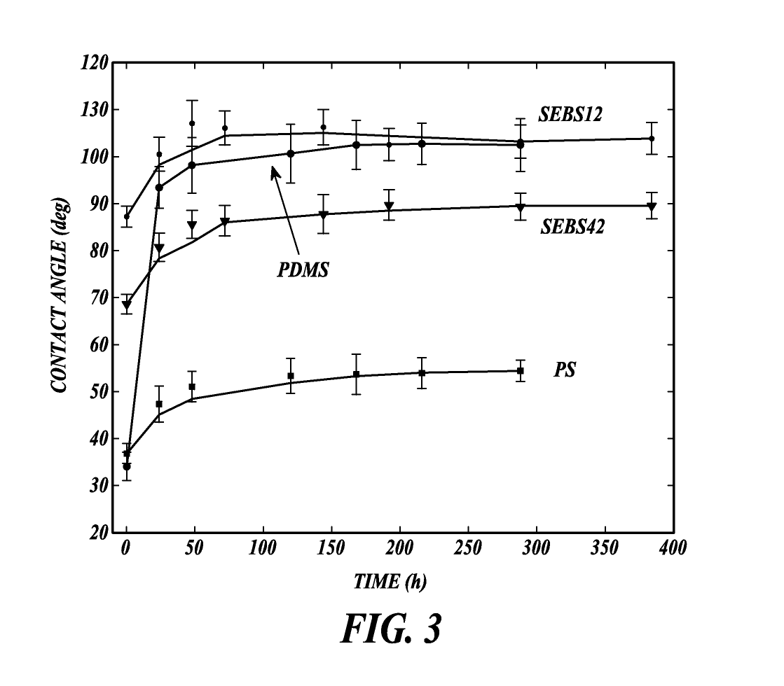

Oxygen plasma treatment is often used to oxidize the native surface of polymers in order to create a more hydrophilic surface for passive flow of polar liquids such as aqueous solutions, to clean and bond the substrates, and to assist in cell attachment. PDMS has a well-known limitation of fast hydrophobic recovery following surface oxidation due to the low glass transition temperature of PDMS (−120° C.) and the resultant mobility of uncross-linked hydrophobic oligomers in the bulk that are able to migrate to the surface. The advancing contact angle of native PDMS is 108°. FIG. 3 shows the rapid (<24 h) hydrophobic recovery of PDMS from an initial hydrophilic state with a contact angle of 30° to a hydrophobic state of approximately 97-100°. High spatial variability of the recovery was observed across the surface, which resulted in a non-uniform wetting surface. In contrast, PS presents a hydrophilic surface following plasma treatment with a much slower and less severe hydrophobic recovery from 35° to 50° over the course of three days with less spatial variation in the contact angle.

Following relatively mild plasma treatment of 10 sccm of O2 at 30 W for 5 min, the SEBS surface exhibits a moderately hydrophilic surface as seen in FIG. 3. The SEBS42 surface undergoes a recovery from 70 to 85° over the course of 3-4 days with spatial variation similar to PS. SEBS42 is less hydrophilic than PS following plasma treatment and after recovery, but undergoes a similar recovery time. Compared to PDMS, SEBS42's surface is more hydrophilic and stable (i.e., slower recovery, smaller change in contact angle during recovery, and less spatial variation in contact angle). SEBS12 substrate recovers to a hydrophobic surface similar to PDMS as a result of limited rigid PS blocks in the bulk and at the surface. Note that higher power plasma treatment increases the degree of wetting for all substrates, although the recovery trends (i.e., recovery time and change of contact angle) were expected to remain similar to the presented data. The wettability of SEBS42 indicates that the surface is suitable for cell attachment and passive flow of polar liquids—both important factors in biological microfluidic experiments.

Stability of the zeta potential, a fundamental parameter of electrical double layer models, is important for substrates used in electrokinetic separation techniques and other microfluidic applications involving electroosmotic flow. The zeta potential normalized by the negative logarithm of the counterion concentration, ζ/pC, of the native surface of SEBS42 cast on SU-8 is −39.5±4.4 mV (pC=1.824), as determined by current monitoring experiments using 9.5 and 10 mM phosphate solutions (pH=6.92) and an applied voltage of 200 V. The zeta potential is similar to typical values reported for current monitoring experiments conducted on various polymers, such as PS, PE, and PDMS. More importantly, the zeta potential for SEBS42 showed consistency between devices (and batches) and for measurements made over the course of several weeks. In contrast to PDMS, SEBS42 devices can be stored in air. SEBS42 surface offers a stable, consistent surface for electrokinetic experiments with very simple device fabrication and use.

Another advantage of the SEBS42 devices relative to PDMS is the ease in filling of the channels using aqueous solutions without formation of bubbles at atmospheric conditions. Conversely, PDMS devices will often retain bubbles while filling and spontaneously form bubbles in filled channels due to its high gas permeability and hydrophobicity. For these reasons, PDMS devices are most often used promptly after plasma treatment, with chemically modified surfaces, or under sustained pressure from syringe pumps or pressure reservoirs. Water filled SEBS42 microchannels do not form bubbles in the channels when allowed to sit in open air for weeks, demonstrating that these issues are mitigated in SEBS devices.

### Cell Biocompatibility

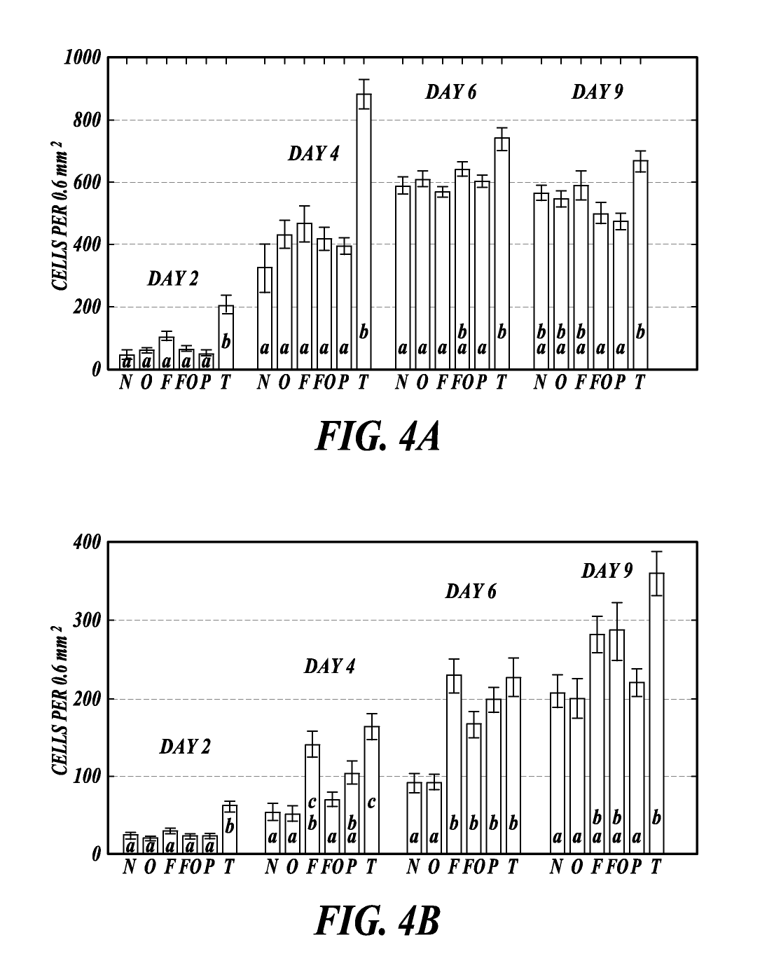

FIGS. 4A and 4B illustrate the growth of 3T3 (FIG. 4A) and BPAEC (FIG. 4B) cells over nine days on SEBS substrates subjected to different treatments: native surface, ozone treated, fibronectin (FN) coated, and ozone/FN. The number of cells on these substrates are directly compared with cells seeded onto tissue culture (TC) dishes and PDMS substrates coated with FN for culturing times of 2, 4, 6 and 9 days.

FIG. 4A is shows 3T3 cell growth on embodiments of SEBS substrates (N native, O=ozone treatment, F=fibronectin treatment, FO=ozone/fibronectin treatment), PDMS substrates treated with fibronectin (P), and tissue culture dishes (T) over the course of nine days. Peaks labeled with the same letter do not significantly differ from each other (α=0.05). Peaks labeled with two letters do not significantly differ from peaks with either of the corresponding letters (i.e., are intermediate). FIG. 4B shows BPAEC cell growth on various SEBS substrates (N=native, O=ozone treatment, F=fibronectin treatment, FO=ozone/fibronectin treatment), polydimethylsiloxane (“PDMS”) treated with fibronectin (P), and tissue culture dishes (T) over the course of nine days. Peaks labeled with the same letter do not significantly differ from each other (α=0.05). Peaks labeled with two letters do not significantly differ from peaks with either of the corresponding letters (i.e., are intermediate). SEBS treated with F does not differ significantly from the TC dish after day 2 and in most cases, PDMS growth is similar to SEBS. The error bars indicate ± one standard deviation. For BPAEC growth, SEBS treated with F does not differ significantly from the tissue culture dish after day 2 and in most cases, PDMS growth is similar to SEBS. The error bars indicate ± one standard deviation.

On TC dishes, 3T3s proliferate and reach confluence by day 4. Throughout the entire experiment, the four treatments of SEBS and PDMS showed no statistically significant difference (α=0.05) for the 3T3 cells. As PDMS with FN treatment has been noted as a good substrate for culturing 3T3 cells, this result indicates that SEBS with any treatment is a suitable substrate for 3T3 growth. On days 2 and 4, the TC dish demonstrates significantly greater growth than the SEBS and PDMS substrate. At longer growth times however, the SEBS substrates and TC dish growth are more comparable. There is no significant difference between the native, ozone treated, or FN coated SEBS and the TC dish on day 9, though this may be due in part to cell detachment following the TC dish reaching confluence early in the experiment.

The BPAEC cells are primary epithelial cells that are more sensitive to culture conditions. As shown in FIG. 4B, this sensitivity results in larger variance in cell growth between the substrates. On TC dishes, BPAEC cells reach confluence by day 9. The TC dish shows greater initial attachment than all other substrates on day 2 and the native SEBS and SEBS with ozone treatment experienced significantly less growth than the TC dish throughout the experiment. On days 4-9 however, SEBS with FN coating exhibited growth similar to the TC dish that did not significantly differ on any of the days. In general, the PDMS demonstrated growth that was intermediate between the low growth substrates and higher growth SEBS substrates. FIGS. 4A and 4B show the full results of statistical testing (α=0.05) between substrates for each day and cell type.

Overall, these results show that SEBS is capable of promoting adhesion and proliferation of different cell line. Moreover, independent of the treatment, SEBS can promote cell adhesion and proliferation at least as well as PDMS with FN, while the cell growth appears to be generally comparable to standard tissue culture dish cell growth for SEBS with FN.

### Absorption and Optical Properties

PDMS has a tendency to sorb small hydrophobic molecules into its high free volume matrix. Experiments that require the use of hormones or other small molecule drugs, as well as quantitative dye studies can be challenging in PDMS micro/millifluidic devices due to these intrinsic material properties. For PDMS, molecule sorption can be reduced and biocompatibility can be improved using treatments such as sol-gel method or coating with paraffin or parylene, but this introduces further processing steps for the fabrication of micro/millifluidic devices simply due to material limitations.

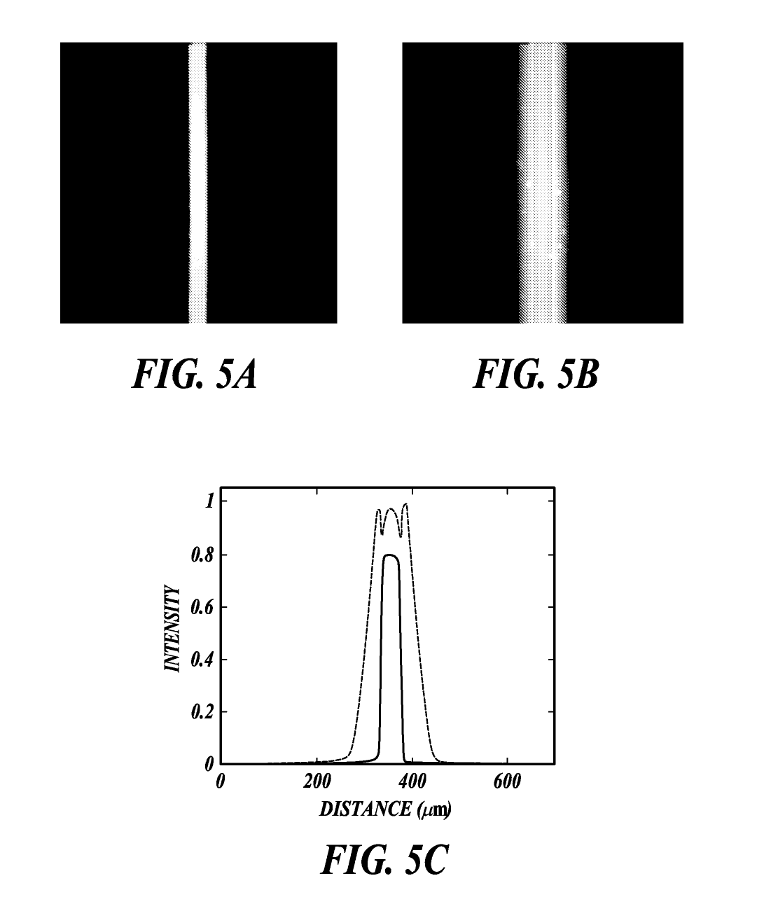

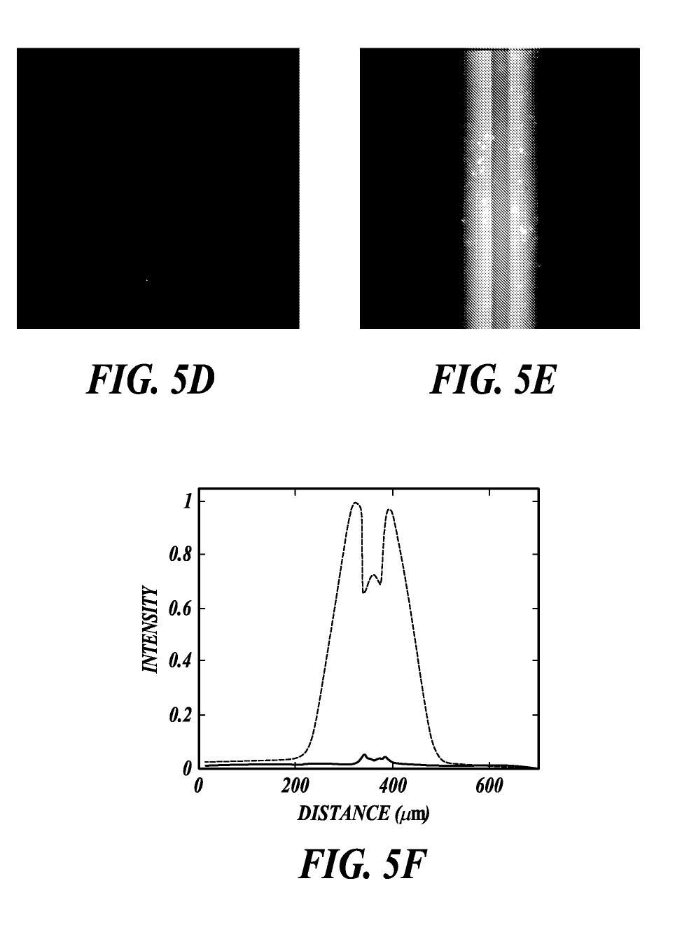

Rhodamine B is a small hydrophobic dye that can demonstrate these issues associated with sorption in PDMS. FIGS. 5A-5F show 50 μm wide channels filled with 100 mM rhodamine B using native SEBS42 cast on SU-8 and native PDMS. As seen in FIG. 5B and the corresponding intensity profile (FIG. 5C), rhodamine B strongly absorbs into the PDMS with significant penetration into the bulk. Despite significant washing with DI water following incubation, the channel and the walls of the PDMS remain fluorescent (FIGS. 5E, 5F) demonstrating its tendency to irreversibly sorb small hydrophobic molecules. Conversely, SEBS42 does not appear to have any absorption of rhodamine B into the bulk material (FIGS. 5A, 5C). Following a thorough washing with DI water, the fluorescent signal of the dye in SEBS is essentially removed from the material (FIGS. 5D, 5F). These results match well with those performed on pure PS and indicate that the adsorption and absorption of small hydrophobic molecules with SEBS are as little as 0 when compared to PDMS.

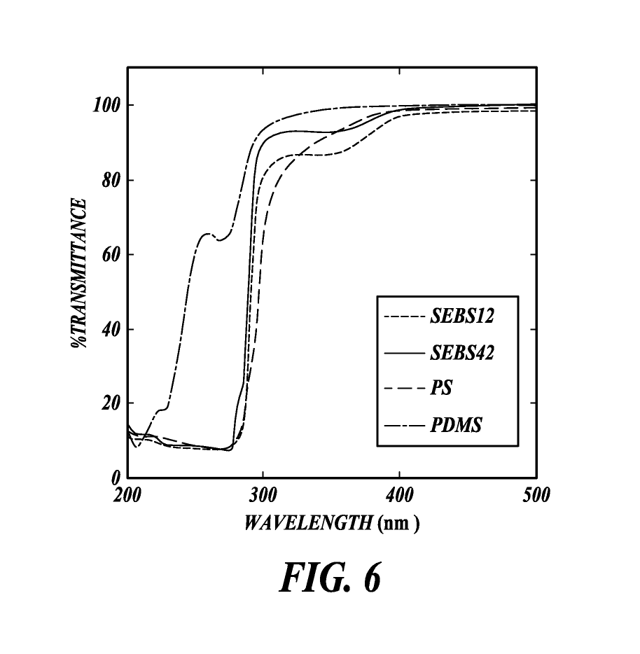

The ability to clearly image experimental progress in micro/millifluidic chips, either through optical or fluorescent readings is an essential property for any LOC device. FIG. 6 shows the fractional transmittance for SEBS42, SEBS12, PDMS, and homo PS in the UV and low-visible spectra ranges. All four polymers have similar transmittance in the high UV-visible range (400-800 nm), nearing 100% transmittance. At shorter wavelengths (200-300 nm), PDMS exhibits greater transmittance than the other polymers, with the SEBS demonstrating slightly improved transmittance over homo PS in the 200-400 nm range. Autofluorescence studies on SEBS42 also indicate that the background fluorescence of SEBS42 is low and comparable to PS cuvette standards. This can be useful during quantitative dye imaging studies to reduce background noise.

Thus, micro/millifluidic devices fabricated from SEBS containing high PS content combine many of the advantages of PS that make it the biological material of choice with elastomeric properties that offer convenient methods for microfabrication and interfacing of the standard PDMS. Structural features with high resolution and fidelity can be easily replicated in SEBS through a bench-top replica molding process requiring basic lab equipment and readily available solvent, such as toluene or other high boiling point solvents such as 1,2,4-trimethylbenzene and mesitylene. Analysis of the surface composition indicates that substrate and bulk polymer choice has a significant effect on the amount of PS at the surface of the polymeric devices. SEBS42 casted onto different substrates experienced increasing PS surface concentration on silane, SU-8, and silicon surfaces respectively. In terms of practical use, silane treated wafers offer the greatest durability, followed by the all SU-8 wafers, which allow for easier de-molding than untreated silicon, but degrade over time.

Contact angle measurements indicate that the surface of SEBS42 is marginally hydrophobic, but can be made hydrophilic following oxygen plasma treatment before undergoing moderate hydrophobic recovery over the course of a few days. The SEBS42 surface is biocompatible and able to support cell growth that is not significantly different from PDMS for any of the treatments and cell types tested. Also, SEBS42 treated with FN shows cell growth that is generally comparable to standard tissue culture dishes. Other advantageous properties of SEBS include varying mechanical stiffness with bulk PS content, a stable surface zeta potential, high optical transparency, low autofluorescence, little to no adsorption and absorption of small hydrophobic molecules, and moderate gas permeability when compared to PDMS and hard thermoplastics. Overall, SEBS and its thermoplastic elastomer nature, offers a versatile platform for cellular biology micro/millifluidic applications and research.

### Example 2

### Zeta Potential Measurements

Zeta potential of SEBS42 in Example 1 was measured. Microchannels 200 μm wide, 50 μm tall, and 4 cm in length were fabricated by casting on all SU-8 wafers. The microchannels ports were punched using a syringe needle, thermally bonded at 75° C. to a flat SEBS substrate, and PS cylinder wells were attached using UV-curable epoxy. Stock 100 mM phosphate buffer solution was prepared at 22° C. by mixing equimolar sodium phosphate dibasic and sodium phosphate monobasic in DI water before dilution to 9.5 and 10 mM concentration. The bulk conductivities of the phosphate solutions were measured using a high-precision conductivity meter. The 9.5 mM phosphate solution measured λ_{b}=1346 μS cm⁻¹ and the 10 mM phosphate solution measured λ_{b}=1285 μS cm⁻¹. The diluted samples had a pH of 6.92, measured at 22° C. Multiple measurements were made on at least three devices from different batches over the course of multiple weeks at a temperature of 22.0±0.5° C.

The channel was thoroughly washed with 100 mM NaOH, DI water, and 9.5 mM phosphate buffer solution before monitoring. Both wells and the channel were filled with 9.5 mM phosphate buffer solution using a syringe with a 0.2 micron filter and a potential difference of 200 V was applied via platinum electrodes placed into each well using a remote source meter (Keithley 6430, Cleveland, Ohio) until a constant current was observed. One channel was then cleared with vacuum and injected with 10 mM phosphate solution through using a syringe with a 0.2 micron filter. A 200 V potential difference was applied and the change in current with respect to time was monitored using source meter and recorded using Labview. The zeta potential was calculated using the slope of the current-time plot and the Smoluchowski equation. Stability of the zeta potential, a fundamental parameter of electrical double layer models, is important for substrates used in electrokinetic separation techniques and other micro/millifluidic applications involving electroosmotic flow. The zeta potential normalized by the negative logarithm of the counterion concentration, ζ/pC, of the native surface of SEBS42 cast on SU-8 is −39.5±4.4 mV (pC=1.824), as determined by current monitoring experiments using 9.5 and 10 mM phosphate solutions (pH=6.92) and an applied voltage of 200 V. The zeta potential is similar to typical values reported for current monitoring experiments conducted on various polymers, such as PS, PE, and PDMS. More importantly, the zeta potential for SEBS42 showed consistency between devices (and batches) and for measurements made over the course of several weeks. In contrast to PDMS, SEBS42 devices can be stored in air. SEBS42 surface offers a stable, consistent surface for electrokinetic experiments with very simple device fabrication and use.

### Example 3

### Contact Angle Measurements

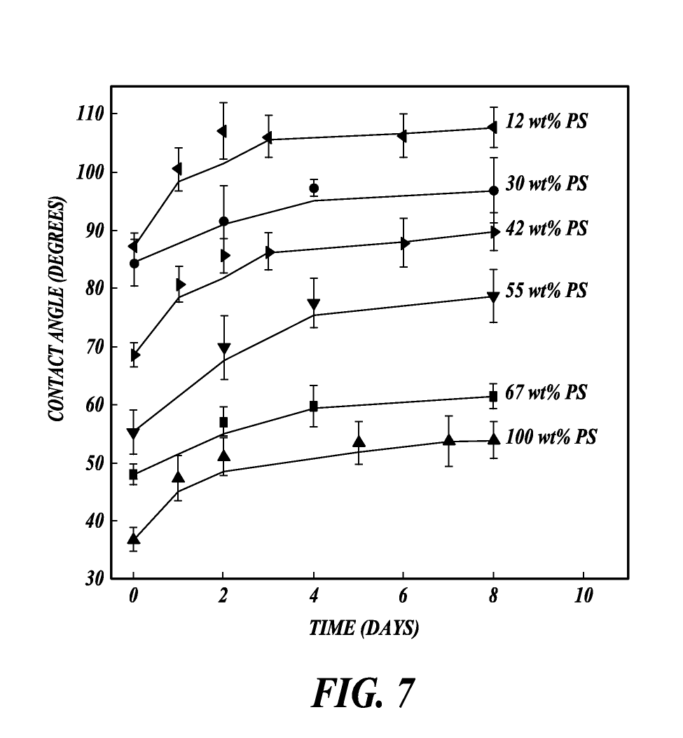

Contact angles of SEBS with varying PS wt % were measured as described in Example 1. FIG. 7 is a plot showing contact angles for SEBS with varying PS wt %. All of the SEBS were cast from SU-8 wafers and exposed to oxygen plasma for 5 min at 30 W and 10 sccm O₂. The figure shows the trend of increasing hydrophilicity with increasing PS wt %.

While illustrative embodiments have been illustrated and described, it will be appreciated that various changes can be made therein without departing from the spirit and scope of the invention.

Accordingly, other embodiments are within the scope of the following claims.

1. An article, comprising a polystyrene-b-poly(ethylene-co-butylene)-b-polystyrene having a styrene content of between 15 wt % and 70 wt %, wherein the article comprises a predetermined structural feature having a dimension of 20 nm to 1 cm.

2. The article of claim 1, wherein the article has a first major surface and a second major surface opposing the first surface, and wherein the styrene content of the first major surface is greater than the styrene content of the second major surface.

3. The article of claim 1, wherein the polystyrene-b-poly(ethylene-co-butylene)-b-polystyrene has a styrene content of between 25 wt % and 70 wt %.

4. The article of claim 1, wherein the polystyrene-b-poly(ethylene-co-butylene)-b-polystyrene has a styrene content of between 30 wt % and 45 wt %.

5. The article of claim 1, wherein the polystyrene-b-poly(ethylene-co-butylene)-b-polystyrene has a styrene content of 42 wt %.

6. The article of claim 1, wherein the predetermined structural feature has a dimension of 50 nm to 500 μm.

7. The article of claim 1, wherein the predetermined structural feature is a channel and the dimension is a channel width.

8. The article of claim 1, wherein the predetermined structural feature is a well and the dimension is a width, length, or both the width and length.

9. The article of claim 1, wherein the predetermined structural feature is a protrusion and the dimension is a protrusion width.

10. The article of claim 1, wherein the predetermined structural feature is a protrusion and the dimension is a protrusion height.

11. The article of claim 1, wherein the predetermined structural feature is a region on a surface of the article.

12. The article of claim 1, comprising an array of predetermined structural features.

13. The article of claim 1, further comprising polystyrene in a blend with the polystyrene-b-poly(ethylene-co-butylene)-b-polystyrene.

14. An article, comprising a polystyrene-b-poly(ethylene-co-butylene)-b-polystyrene having a bulk styrene content of between 15 wt % and 70 wt % and a surface styrene content that is different from the bulk styrene content, wherein the article comprises a predetermined structural feature having a dimension of 20 nm to 1 cm.

15. The article of claim 14, wherein the surface styrene content is less than the bulk styrene content.

16. The article of claim 14, wherein the surface styrene content is more than the bulk styrene content.

17. A method of making an article, comprising:
providing a mold comprising a predetermined structural feature imprint;
supplying the mold with a polystyrene-b-poly(ethylene-co-butylene)-b-polystyrene;
setting the polystyrene-b-poly(ethylene-co-butylene)-b-polystyrene to provide an article of claim 1; and
removing the article from the mold,
wherein the mold comprises a hydrophilic surface, a hydrophobic surface, or a combination thereof.

18. The method of claim 17, wherein the mold comprises a surface energy of 10 to 80 mJ/m².

19. The method of claim 17, wherein the mold comprises a predetermined hydrophilic, hydrophobic, or hydrophilic and hydrophobic surface pattern.

20. The method of claim 17, wherein the mold is reuseable.

21. The method of claim 17, wherein supplying the mold with polystyrene-b-poly(ethylene-co-butylene)-b-polystyrene comprises solution casting, injection molding, or thermal embossing the polystyrene-b-poly(ethylene-co-butylene)-b-polystyrene in the mold.

22. The method of claim 18, further comprising bonding the article to a substrate comprising glass or a polymer.
